(19) United States
(12) Patent Application Publication
(10) Pub. No.: US 2008/0317915 A1
(43) Pub. Date: Dec. 25, 2008

(54) Casings for Foodstuffs

(75) Inventors: Xiaopei Hu, Manitowoc, WI (US); Paul E. DuCharme, JR., Elkhart Lake, WI (US)

Correspondence Address: MARSHALL, GERSTEIN & BORUN LLP, 233 S. WACKER DRIVE, SUITE 6300, SEARS TOWER, CHICAGO, IL, 60606, US

(73) Assignee: RED ARROW PRODUCTS CO., LLC., Manitowoc, WI (US)

(21) Appl. No.: 12/103,751

(22) Filed: Apr. 16, 2008

Related U.S. Application Data
(60) Provisional application No. 60/925,265, filed on Apr. 18, 2007.

(51) Int. Cl. A23P 1/12

(52) U.S. Cl. 426/277

(57) ABSTRACT

A continuous method of manufacturing an encased foodstuff via coextrusion is disclosed.

### CROSS REFERENCE TO RELATED APPLICATIONS

This application claims the benefit of U.S. provisional patent application No. 60/925,265, filed Apr. 18, 2007.

### FIELD OF THE INVENTION

The present invention relates to casings for foodstuffs. More particularly, the present invention relates to edible casings for foodstuffs comprising collagen and an optional polysaccharide, and to methods of manufacturing the casings. The present method also relates to a coextrusion method of manufacturing an encased foodstuff, such as a sausage product, having a collagen or a collagen/polysaccharide casing.

### BACKGROUND OF THE INVENTION

Sausages are encased protein products providing an efficient and effective vehicle for delivering a specific quantity of a protein. Sausages also are a food of choice for quick, nutritious meals at home and in restaurants.

Sausage products are popular because they can be made from almost any protein source, cover a range of prices, and the number of flavors, sizes, shapes, and textures are essentially unlimited. Sausages can be eaten fresh or cured by smoking, cooking, dehydration, or other curing technique known in the art. The curing step provides consumer desired flavors and textures, as well as relative safety from foodborne pathogens. Cured sausages often are consumed without additional cooking. Sausages made from fresh meat products are cooked prior to consumption. Thus, all sausages must be cooked, cured, and dried, or otherwise treated to control foodborne pathogens prior to consumption.

A typical method of producing a sausage includes grinding the protein and mixing the ground protein with salt, curing agents (if applicable), spices, flavors, sweeteners, extenders (such as milk solids, starch, cereal, and the like), and water prior to stuffing into a tubular casing. Casings can be natural or manufactured. Natural casings can be animal intestine, derived from, for example, cattle, pigs, or sheep. However, natural casings have an uneven thickness, are structurally inconsistent, and can have religious restrictions. In addition, natural casings require careful cleaning and preparation, are in short supply, and are relatively expensive. Casings also can be manufactured from edible and inedible polymers, such as cellulose, starch, collagen, nylon, or other natural and synthetic polymers.

If the casing material is digestible, such as collagen or various animal intestines, then the casing is consumed with the sausage. If the casing is indigestible, such as cellulose, then the casing is stripped away from the sausage prior to ingestion. An example of a sausage traditionally made with a casing that is stripped off prior to consumption is the “skinless” hot dog. In this case, the meat emulsion is stuffed into a cellulose casing, then the sausage is smoked, cooked, and the casing is mechanically removed prior to packing for sale.

Artificial edible sausage casings, i.e., casings not based on a natural intestine, have been made, but it has been difficult to provide a casing having a suitable degree of shrinkage when cooked, for example, by frying or boiling. During cooking, sausage meat decreases in volume up to about 15%, and it is desirable that the sausage casing shrinks by an amount sufficient to maintain contact with the sausage meat. On the other hand, casing shrinkage should not be so great that the casing splits and releases the meat during cooking.

Collagen/polysaccharide casings comprise a continuous phase of a polysaccharide, e.g., an alginate, containing a network of collagen fibers. This structure is attained by extrusion of a preformed aqueous gel containing the collagen and alginate. The collagen fibers are readily extruded, aided by the lubricating action of the alginate in the extrusion die, to form a homogeneous, strong casing.

Casings manufactured from collagen alone are known. However, such casings have disadvantages. Extruded collagen casings can be complex to manufacture, have a difficult texture to eat, have different shrink characteristics compared to the encased meat, and tend to shrink excessively during freezing, thereby splitting and releasing the meat and upon reheating. Casings made solely of alginate also demonstrate failure, e.g., poor meat adhesives, attributed to the freeze-thaw cycles the foodstuff often is subjected to.

By blending the two materials before extrusion, a gel results wherein the undesirable extrusion properties of the collagen are modified by the alginate and the undesirable properties of the alginate are modified by the collagen. For example, the resulting casing is desirable because it shrinks with the meat during cooking, but not to such a degree that the casing splits or extrudes the meat through the sausage ends. In addition, the resulting casing because it has a protein content, is more compatible with the protein-based meat emulsion and exhibits more resistance to thermal processing, i.e., cooking, than an alginate casing.

Collagen is a fibrous sclero protein, and is the preferred fibrous protein for use in the present invention. However, it should be understood that another fibrous protein, such as a keratin or an elastin, can be substituted for the collagen, either in part or in whole.

Collagen used in the encasement of food products typically is recovered from bovine and other animal skins by well-known processes. Sources of collagen include, but are not limited to, connective tissue, skin cartilage, bones, tendons, and intestines. The typical process for producing commercial collagen uses the corium layer of animal hides, known in the art as “hidesplits.” Hidesplits are washed, optionally chemically treated to reduce natural crosslinking levels, and finally acid softened. The softened hidesplits are converted to a stable, pumpable gel by various operations, including, but not limited to, grinding, milling, and homogenization. Various processing aids that improve collagen casing properties can be added during this converting process.

The product of this process is an aqueous gel-like material containing 3% to 7%, by weight, collagen solids and a pH of about 2 to about 4. This type of collagen is termed “acid collagen,” and is commonly used to produce a shaped, tubular casing for the production of a variety of sausage products, such as pork breakfast sausages, ring bologna, bratwurst, hot dogs, chorizo, and related products. The collagen casing is edible and fully digestible.

In addition to casings containing solely collagen, the present invention also is directed to a collagen/polysaccharide casing, and in particular a collagen/alginate casing. Although, the polysaccharide typically is an alginate, other polysaccharides having carboxyl groups, such as pectic acid, can be used in place of alginate, in part or in whole.

The weight ratio of collagen to polysaccharide in the gel ranges from 100:0 to about 30:70, and preferably about 80:20 or about 90:10 to about 40:60, or about 70:30 to about 50:50, on a dry weight basis. The actual preferred gel of collagen and polysaccharide contains about 2% to about 7%, preferably about 3% to about 6%, and more preferably about 3.5% to about 5.5%, by weight, of the collagen. The blend also contains about 1% to about 5%, and preferably about 2% to about 4%, by weight of the polysaccharide.

There are other methods of using collagen for the encasement of sausages. It is known to coextrude a strand of sausage having (a) an inner core of ground, comminuted meat and (b) an outer surface material that can be coagulated to provide a casing for the strand of ground meat. The outer surface material can be a collagen gel protein. Coagulation of the casing typically includes subjecting the extruded strand to a brine solution. The resulting sausages therefore are drawn through, drenched, or sprayed with a salt bath to dehydrate and harden the collagen casing. The brine is applied immediately after the strand is extruded.

For many reasons, a collagen casing is not suitable for all types of sausages. In particular, the dehydrating bath used to stabilize, strengthen, and harden the collagen-encased sausages also draws water from the meat product within the collagen casing. When meats such as hot dogs, bratwurst, chorizo, and ring bologna are coextruded with a collagen encasement, they are immediately drawn through a stabilizing salt bath that contains sodium, potassium, ammonium, or calcium salts, such as chlorides, nitrates, phosphates, sulfates, and the like. These aqueous salt solutions are referred to in the art as a “brine.” A commercial brine typically is a concentrated, e.g., a saturated or near, e.g., at least 70%, saturated, aqueous sodium chloride solution. Dipotassium phosphate brines have been used because they have very strong dehydration characteristics and have a much higher solubility. However, dipotassium phosphate is considerably more expensive than sodium chloride. Sodium bicarbonate also has been used as salt in a brine, but due to cost/solubility considerations has been abandoned in favor of sodium chloride or dipotassium phosphate brines. When the casing is a collagen/alginate casing, the brine typically contains calcium ions, e.g., a “calcium brine”. The source of the calcium ions can be an inorganic salt, e.g., calcium chloride and/or calcium nitrate, and/or an organic salt, e.g., calcium lactate and/or calcium citrate.

As discussed above, a collagen/polysaccharide casing is set after extrusion by contact with a calcium brine. The source for calcium ions typically is calcium chloride because calcium chloride is inexpensive and highly soluble in water. However, the calcium ion source for setting the collagen/polysaccharide gel comprises calcium lactate and/or a similar calcium salt, such as calcium citrate.

In particular, in this embodiment of the present invention, the calcium source comprises a water-soluble calcium salt of a carboxylic acid, i.e., a water solubility of at least 0.1 grams of the salt per 100 grams of water at 25° C. The preferred calcium salt comprises calcium lactate. The calcium lactate can be the sole calcium ion source, or can be used with other calcium compounds, like calcium chloride. Calcium lactate is sufficiently soluble in water to provide a viable setting solution. It also should be noted that other calcium salts of an organic carboxylic acid can be used as the calcium ion source, either alone, in combination with calcium lactate, or in combination with one another. One useful calcium salt, for example, is calcium citrate.

When the encased sausage is contacted with a brine solution, water is drawn from the collagen casing, thereby effectively densifying the collagen polymer chains and creating a stable, hardened structure that holds and protects the sausage. The syneresis effects of the brine also can draw water from the inner core of meat or meat emulsion. If the particular sausage being produced is a type that allows incorporation of additional quantities of water, the additional water is not harmful because the resulting sausage can withstand a degree of dehydration during the encasement hardening procedure.

However, this is an undesirable effect for sausage products that permit only a few percent of water to be added to the meat during processing because any water that is drawn from the meat during hardening of the casing results in diminished profitability. Thus, in developing a coextrusion process for these types of sausage products, a method different from dehydration is used to harden and stabilize the sausage casing.

One example of a sausage wherein a different type of casing stabilizing, or hardening, is necessary is termed “fresh sausages”, which are cooked by the consumer just prior to consumption. Fresh sausages can be frozen or unfrozen. Examples of this type of sausage product are fresh breakfast, pork, vegetable, and turkey sausages.

The standard for fresh sausages is very strict and only small amounts of water, i.e., up to 3%, can be added. Thus, when producing fresh sausages, the hardening and stabilizing process for the collagen casing cannot involve dehydration and a different means stabilization must be used. It is possible to admix a hydrocolloid with collagen such that the hardening, stabilization step does not require dehydration. Such an admixture is stabilized by a chemical process not involving dehydration and syneresis.

Hydrocolloids are polymers that gel by absorbing water and are a natural choice for use with collagen. Examples of hydrocolloids are polysaccharides, such as natural gums, like gum acacia, gum Arabic, carrageenan, alginic acid, and salts thereof, and galactomannans, such as guar gum. In addition, many water-soluble polymers, such as polyvinyl alcohol, polyacrylic acid, and the like, and some starches and modified starches, and cellulose derivatives, such as hydroxypropyl methyl-cellulose, also can form gels when contacted with water. The preferred hydrocolloid is sodium alginate, which rapidly forms strong gels when contacted with multivalent metal cations such as, but not limited to, calcium, barium, aluminum, magnesium, and the like.

Alginates are salts of alginic acid, which is derived from seaweed. Alginates are carbohydrate polymers composed of two epimeric monomers, alpha-(1,4)-L-guluronic and beta-(1,4)-D-mannuronic acids. Due to their high carboxyl and hydroxyl group content, alginates crosslink and gel when contacted with multivalent metal cations. For food-related uses, calcium ion is the multivalent cation of choice.

Crosslinking of alginates by metal ions bridges two reactive sites, for example, an acid group and a hydroxyl group, in the same alginate chain or in different alginate chains. Therefore, treatment of a sodium alginate with an aqueous solution containing multivalent metal cations produces strong gels.

When sodium alginate is admixed with collagen in certain proportions, the entire mass gels and becomes firm and stable. The addition of an alginate to collagen presents a problem because a collagen gel typically is acidic having a pH in the range of 2.1 to 3.2. Alginates, however, are primarily carbohydrates containing numerous glycosidic bonds that are not stable in acidic environments. Accordingly, the alginate gel degrades when admixed with acid collagen. This problem can be resolved by a partial neutralization of collagen acidity to raise the pH to about 3.7 to 5.0. In this pH range, the collagen and alginate gel does not degrade, and the collagen/alginate gel rapidly hardens and stiffens when contacted with a solution containing multivalent metal ions. Calcium salts are a preferred choice for this step because they are readily available, approved for food use, and inexpensive. For example, the gelling reaction occurs rapidly and thoroughly within several seconds of contact with a 5-30%, by weight, calcium chloride solution.

Recently, process developments substantially increased use of the continuous coextrusion process. Sausage products, traditionally thermally processed in heated and humidity controlled air systems, are now being produced as “cook in bag” systems, wherein a partially cooked product is packaged in a plastic package, then final cooked in the package. This process has distinct food safety advantages because the sausage product, once in the package, is fully cooked in the package and is not exposed to the handling risks of traditional sausage making and packaging systems. The sausage product is isolated from contamination sources by the packaging, which insures product safety.

With this improved food safety performance, sausage manufacturers using coextrusion utilize less extensive plant sanitation procedures, and extend the actual coextrusion manufacturing time between sanitation procedures. This coextrusion running time has been extended typically up to 72 hours, and in some cases up to 144 hours, between sanitation schedules, and while maintaining a high standard of food safety. Normally, one part of the sanitation procedure is to discard the used brine and restart the process with fresh brine.

The present invention is directed to overcoming problems associated with casings prepared from a collagen and an optional polysaccharide, and in particular the brine used to harden the casing in continuous extrusion process that runs, for example, for 16 to 72 hours, and often up to 144 hours, without regenerating the brine solution.

Although food safety concerns have been addressed by continuous coextrusion, long coextrusion run times tend to decrease the pH and increase the titratable acidity of the brine, which in turn adversely affects the structural integrity of the collagen casings. The present invention is directed to assist in maintaining the useful activity of a brine over an extended sausage production run.

### SUMMARY OF THE INVENTION

The present invention is directed to a method of preparing a casing for a foodstuff from an aqueous gel comprising a collagen and an optional polysaccharide. The present invention is further directed to a casing prepared by the methods disclosed herein, and to foodstuffs comprising an extruded meat product encased in a collagen-based casing of the present invention.

One embodiment of the present invention is a method of preparing a casing for a foodstuff comprising: (a) providing an extrudable foodstuff; (b) providing a gel comprising an acid collagen; (c) coextruding (a) and (b) to form a layer of the gel (b) on the foodstuff (a); then (d) setting the extruded gel over the encased foodstuff by contacting the gel with a brine solution, said brine solution comprising about 0.1% to about 3%, by weight, of a buffer. In another embodiment, the gel (b) further comprises a polysaccharide.

In accordance with the present invention, the method allows long sausage production runs without an appreciable decrease in brine activity, thereby providing a casing of uniform structural integrity throughout the production run. Therefore, one aspect of the present invention is to provide an improved method of manufacturing a casing for a foodstuff comprising collagen and an optional polysaccharide, e.g., an alginate.

Another aspect of the present invention is to provide a casing for a foodstuff from an aqueous collagen gel, wherein the brine is maintained at a pH above about 3, and preferably above about 4, throughout the extrusion process. Another aspect of the present invention is to maintain the brine at a titratable acidity (as lactic acid) below about 0.2 mg/ml, and preferably below about 0.15 mg/ml.

Still another aspect of the present invention is to form a casing by contacting an extruded collagen gel with a brine solution containing a sufficient amount of a buffer, such as sodium bicarbonate, to maintain a brine pH of above about 3, and preferably above about 4, throughout an extended sausage production run.

Yet another aspect of the present invention is to provide a collagen casing prepared in a continuous extrusion process, e.g., a 16 to 144 hour process, without an adverse effect in casing structural integrity throughout the extended process.

These and other novel aspects of the present invention will become apparent from the following nonlimiting detailed description of the preferred embodiments.

### BRIEF DESCRIPTION OF THE FIGURES

FIG. 1 contains plots of brine pH vs. time and % titratable acid (lactic acid by weight, sodium chloride) vs. time showing the decrease in brine pH and increase titratable acidity of a 20%, by weight, sodium chloride brine during the course of a simulated sausage production run;

FIG. 2 contains plots of pH vs. time (minutes) showing the buffering effect for a varying weight percent of sodium bicarbonate in an aqueous brine containing 20% sodium chloride and 1% lactic acid, by weight;

FIG. 3 contains plots of pH vs. wt % lactic acid showing the buffering effect for a varying weight percent of sodium bicarbonate in an aqueous brine system containing 0%, 0.5%, 1%, 1.5%, and 2%, by weight, sodium bicarbonate;

FIG. 4 contains plots of brine pH vs. time and % acid (lactic acid:acetic acid=2:1) vs. time showing the buffering effect of 1.5%, by weight, sodium bicarbonate in a 20%, by weight, sodium chloride brine; and

FIG. 5 contains plots of pH vs. time (hours) and lactic acid (g/100 ml) vs. time showing the buffering effect of 1%, by weight, sodium bicarbonate in a 20%, by weight, sodium chloride brine.

### DETAILED DESCRIPTION OF THE PREFERRED EMBODIMENTS

A collagen casing of the present invention is prepared by admixing an aqueous slurry of collagen fibers and an optional polysaccharide, e.g., an alginate, extruding the resulting mixture to the desired form, and then setting or hardening the mixture, typically by use of a brine.

In coextrusion processes, the length of a single sausage production run is about 16 to about 144 hours. Because the brine system is essentially a captive, recirculated system, these extended run times lead to increased titratable acidity levels which results in casing performance issues. In particular, the recirculated brine extracts acids from the collagen gel and the pH of the brine is reduced. When the brine pH is sufficiently lowered, the collagen casing is softened and degraded. Therefore, the present invention is directed to maintaining a brine pH above about 3 and a titratable acidity (as lactic acid) below about 0.2 mg/ml for an entire extended production run.

The main function of the brine system is to dehydrate and reform the collagen structure from the extruded gel into a secure encasement for the sausage emulsion. For collagen/alginate systems, the function of the brine is to crosslink the alginate and form a casing of sufficient structural integrity to encase the sausage emulsion. Together with water removal/crosslinking from the collagen-based gel casing, inorganic and/or organic acids used in the manufacture of the collagen gel are extracted. Because of the extended manufacturing run times between sanitation procedures, i.e., brine replacement, titratable acid levels in the brine increase to a level sufficient to adversely affect, and actually reverse, the collagen gel hardening process. This softens the collagen casing surface making the casing susceptible to abrasion damage and a softer casing surface texture than desired. In such a case, abraded collagen is removed from the casing and accumulates in liquid smoke drench systems, which leads to inconsistent color and flavor performance.

Previously, with more frequent discarding of the brine, brine titratable acidity levels did not increase to a point where product performance issues surfaced. The present invention overcomes these problems.

A general method of making casings according to the present invention is as follows. A source of collagen is washed, then minced and milled, to provide an aqueous paste in which collagen fibers are dispersed to a desired degree. During this process, the temperature of the collagen typically is maintained below 40° C., and preferably below 25° C., to minimize protein denaturation. The optional sodium alginate then is milled with the collagen, and the resulting gel is homogenized to shear the collagen bundles to the desired dimensions. This process also promotes chemical and physical interactions between the collagen and the optional alginate.

The collagen gel or collagen/alginate gel then is extruded through a suitable annular nozzle into a setting solution. A setting solution for a collagen casing typically is a sodium chloride brine. For collagen/alginate casings a particularly suitable setting solution contains di- or trivalent metal ions which precipitate the alginate as an insoluble salt. A preferred setting agent comprises calcium ions. In one embodiment, the formed casing then is inflated by air to assist in further processing and, after washing to remove excess setting solution, the casing is dehydrated to a moisture content of about 10% to about 50%.

More particularly, the method of preparing collagen and collagen/polysaccharide casings is performed as follows. Trimmed cattlehide tannery splits are treated, for example, with calcium hydroxide at a pH of 12 or greater to control microbes, then refrigerated. The treated splits are saturated with calcium salts, which then are thoroughly rinsed from the splits. The splits next are neutralized to a pH less than 7 with acetic acid. The excess acetic acid is removed, and the neutral hides are saturated with sodium sulfate. Sodium hydroxide then is added to cleave crosslinking disulfide bonds, followed by neutralization with acetic acid to pH less than 7. The resulting sodium acetate is rinsed from the hides, which then are treated with lactic acid and acetic acid to soften and swell the hides, i.e., put the hides in a condition for grinding.

In some embodiments, a crosslinker is added to the collagen. The optional crosslinker can be any compound having at least two functional groups. The crosslinker crosslinks the collagen protein with itself, and also potentially with the alginate, and thus increases the stability and strength of the casing. The addition of a crosslinker raises the melting point of the collagen and imparts strength to the collagen. Several different crosslinkers are useful, and are compounds having multiple reactive sites, particularly reactive sites that readily react with nitrogenous and/or hydroxyl moieties. The optional crosslinker can be a diacid, diester, diamine, diepoxy, diacryl chloride, dihalide, or anhydride compound, or a compound having at least two of such functional groups, either the same or different. Additional crosslinkers include, but are not limited to, phosphorous oxychloride and polyphosphates. Typically, the crosslinker is a dialdehyde, e.g., glutaraldehyde, or a hydroxyaldehyde, e.g., a hydroxyacetaldehyde. An example of a useful crosslinker is glutaraldehyde.

The preferred crosslinkers are dialdehydes, which can be derived from the pyrolysis of an organic material, such as sawdust or carbohydrates. Accordingly, a crosslinker can be added to a collagen gel in the form of a liquid smoke product, available for example from Red Arrow Products Co., LLC. Liquid smoke is a very complex mixture of carbonyl containing compounds, such as formaldehyde, glycolic anhydride, glyoxal, acetone, hydroxyacetone, methylglyoxal, diacetyl, and furfural; phenols, primarily phenol, guaiacol, syringol, m-cresol, 4-methylguaiacol, and iso-gugenol; and organic acids, primarily acetic acid. The carbonyl containing compounds of a liquid smoke product serve as efficacious and low cost crosslinkers. Preferably, the liquid smoke product is low in taste and odor so as to avoid adversely affecting the meat product encased by the collagen. The liquid smoke composition can be treated with hydrogen peroxide to reduce taste and odor attributed to the liquid smoke composition. Commercial examples of crosslinkers include MAILLOSE®, available from Red Arrow Products, LLC, Manitowoc, Wis., and the Kymene products. MAILLOSE® contains hydroxyacetaldehyde, a particularly effective crosslinker.

The optional crosslinker is present from 0 to about 5,000 ppm, and typically 10 to about 3,000; 20 to about 2,500; 30 to about 2,000; 40 to about 1,500; or 50 to about 1,000 ppm, based on the weight of the collagen.

The treated hides are reduced to a collagenous paste by passing through a high-speed mincer, and then passed a plurality of times through a colloid mill set to progressively finer clearance, the last typically being a 0.1 mm gap. The collagen is cooled during milling, and the collagen paste so obtained then optionally is mixed with sodium alginate, first in a disintegrator and then in a colloid mill. The resulting gel is deaerated, then extruded through an extrusion annulus to form a casing.

The casing is set by a bath containing an aqueous salt solution, which contacts both the inside and outside surfaces of the casing. After passing from the setting solution, the casing is inflated using pressurized air. The inflated casing is drawn away from the nozzle and washed with water.

Lengths of the casing are wound in an open spiral round a reel, inflated, and dried in a current of air. The casings then are transferred for conditioning to a humidity cabinet maintained at 85% relative humidity and 20° C. After the casing reaches an equilibrium moisture content of 30 to 35%, the casing is spooled and is ready for shirring and stuffing with sausage meat. Preparation of collagen/polysaccharide casings also is disclosed in GB 1,040,770.

The above method describes the preparation of a preformed collagen casing that is stuffed with a meat product at a later date. The present casings also can be prepared using a coextrusion method wherein a collagen or collagen/alginate gel is extruded over the meat product, as the meat product is being extruded. The casing then is set on the meat product by contacting the extruded gel with a solution of metal ions. A preferred setting solution for a collagen casing contains chloride ions, e.g., sodium chloride. A particularly suitable setting solution for a collagen/alginate casing contains di- or trivalent metal ions which precipitate the alginate as an insoluble salt. A preferred setting solution comprises calcium ions from an organic source, an inorganic source, or both.

In accordance with an important feature of the present invention, the aqueous gel of the collagen is set in a brine solution containing a sufficient amount of a buffer to maintain the brine pH above about 3, and preferably above about 4, up to about 8.5, for the entire extrusion process. The buffer typically is present in an amount of about 0.1% to about 3% weight percent of the brine. The brine pH also can be controlled by a continuous addition of a strong base, for example, sodium hydroxide, potassium hydroxide, calcium hydroxide, or a mixture thereof.

It is important to maintain brine pH because the brine extracts acids from the collagen, which drops the pH of the brine to less than 3. In preferred embodiment, the brine pH is maintained above 4, above 5, above 6, above 7, above 7.5, and up to about 8.5. At this pH, the resulting collagen casing has sufficient structural integrity for commercial use. In various embodiments, the buffer maintains the pH of the brine from about 3 to about 8.5, preferably about 4 to about 7.5, and more preferably about 5 to about 7.

Useful buffers include, but are not limited to, potassium tartrate, potassium phthalate, potassium phosphate, dipotassium phosphate, sodium phosphate, borate, potassium oxalate, glycine, citrate, glycylglycine, malate, formate, succinate, acetate, propionate, maleate, MES, bis-tris, ADA, carbonate, bicarbonate, ACES, PIPES, MOPSO, BIS-TRIS propane, BES, MOPS, HEPES, MOBS, DIPSO, TAPSO, pyrophosphate, HEPPSO, POPSO, tricine, trizma, EPPS, HEPPS, BICINE, HEPBS, TAPS, AMPD, TABS, AMPSO, taurine, and mixtures thereof. A preferred buffer is sodium bicarbonate.

A collagen or collagen/alginate gel used in a continuous sausage production run was prepared as follows:

Collagen Preparation

Bovine hide splits were treated with calcium hydroxide to a pH greater than 10, then water washed to remove excess calcium hydroxide. Then, an acetic acid solution was added to neutralize the remaining calcium hydroxide while maintaining process temperatures less than 25° C. Neutralization salts then were removed from the hide splits by water washing. The neutralized, washed hides optionally can be treated with a saturated sodium salt solution, then an alkali solution (1 M) to adjust the amide nitrogen content of the collagen, neutralized and water washed again. Organic acid was added which is absorbed into the collagen, softening and preparing for further mechanical processing, such as grinding. Ground collagen then was mixed with water, cellulose, and other processing acids in a mixing step, using a sigma blade mixer. The resulting protein standardized, pH standardized, blended mixture was processed through multiple high intensity, shear mixing to form a stable aqueous collagen gel suitable for further processing.

Collagen/Alginate Gel Preparation

An aqueous collagen gel, as described above, was added to a high intensity, high shear mixing operation, such as a bowl chopper. Gel pH was adjusted to 3.7-5.0, then optional processing acids were blended into the collagen gel. Alginate then was added in the appropriate amount and with high intensity shear mixing dispersed and dissolved into the aqueous collagen gel. This step can require multiple mixing and rest cycles to successfully disperse, then dissolve, the alginate to form a stable gel dispersion. pH was controlled at less than 5.0, preferably less than 4.6, but above 3.9. The resulting alginate/collagen dispersion then was subjected to an additional high intensity, high speed mixing operation to ensure dispersion stability. Temperature was maintained less than 25° C. to prevent degradation of the collagen.

Preparation of Sausages

The collagen gel dispersion then was utilized in coextrusion equipment, similar to Townsend QX Coextrusion system. The meat and collagen gel were coextruded into a sausage “rope,” regenerated by exposure from 1-60 seconds of a dehydration brine solution, then crimped and cut to desired link size and weight.

The new and unexpected results provided by the present invention are illustrated in the following examples and tests.

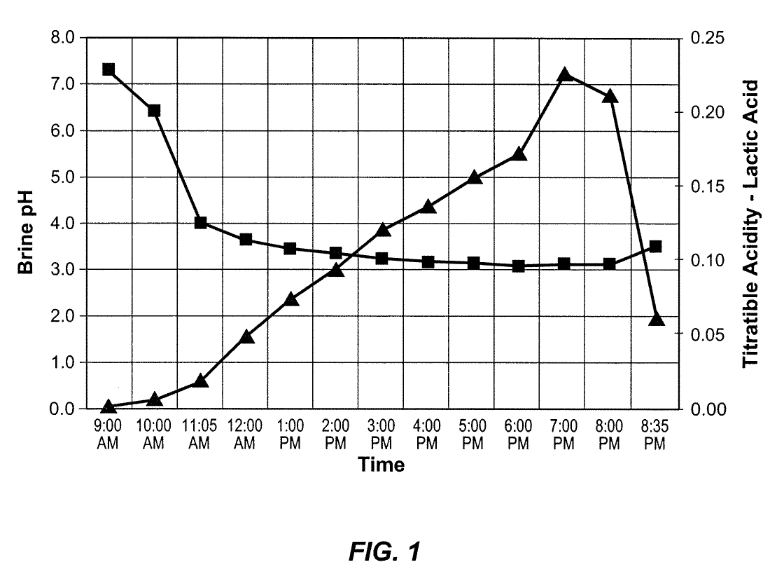

FIG. 1 illustrates the effects of a continuous sausage extrusion run on brine pH and titratable acidity (lactic acid). In particular, a continuous sausage extrusion run was performed for 11.5 hours using a brine containing 20%, by weight, sodium chloride and 0.5%, by weight, sodium bicarbonate. As shown in FIG. 1, the brine pH drops relatively quickly over first two hours of the run, then the pH decrease slows substantially over the next 9.5 hours. Coincidental with the brine pH decrease, the titratable acidity (lactic acid) rises steadily over the first ten hours. The increase in brine pH and drop in titratable acidity is attributed to an addition of aqueous sodium bicarbonate (0.5%, by weight) after about 11 hours. After about 8 hours, the collagen casing prepared by the production run began to show adverse effects, i.e., softness and lack of structural integrity due to an increase in titratable acidity.

FIG. 1 clearly shows that a continuous recycling of the brine extracts acids from the collagen, which results in a pH decrease/titratable acidity increase. As illustrated in FIG. 1, preferred and acceptable operating parameters were observed over the first ten hours of the production run, i.e., a pH of above about 3 to about 7.3 and a titratable acidity (lactic acid) of 0 to about 0.2 g, and preferably to about 0.15 g, lactic acid per 100 ml of brine.

Prior to the present invention, a continuous sausage production run would be interrupted in order to provide a new brine solution, or the brine system would have to be continually regenerated by the addition of fresh brine, for example, to maintain the pH and titratable acidity (lactic acid) in the preferred and acceptable pH and titratable acidity ranges.

In accordance with the present invention, it has been found that adding a buffering agent, such as a sodium bicarbonate to the brine, is an easy and effective way to extend the useful life of a brine. In particular, it was found that adding a buffering agent, such as sodium bicarbonate, in an amount of 0.5%, by weight of the brine, to a brine maintains the brine solution above pH 6 until lactic acid reached 0.2 mg/100 ml brine. At this rate of sodium bicarbonate, the useful life of the brine is about 10 hours.

Using a brine containing 1%, by weight, sodium bicarbonate maintains a brine pH above 6 until the lactic acid level rises to about 0.5 to about 0.75 mg/100 ml of the brine. Using a brine containing 2%, by weight, sodium bicarbonate exhibits a brine pH above 6 up to a titratable lactic acid level of about 1 mg/100 ml brine. However, as the amount of sodium bicarbonate is increased, the amount of carbon dioxide bubbling may cause production problems unrelated to brine pH or titratable acidity (lactic acid) in the preferred and acceptable pH and titratable acidity ranges.

Accordingly, to achieve the full benefits of the present invention, the amount of sodium bicarbonate and/or other buffering agent added to a brine is about 0.1% to about 3%, and preferably 0.2% to about 2.5%, by weight, of the brine. More preferably the brine contains 0.3% to about 2%, or 0.5% to about 2%, by weight, of a buffering agent. The brine therefore can contain about 0.1%, 0.2%, 0.3%, 0.4%, 0.5%, 0.6%, 0.7%, 0.8%, 0.9%, 1.0%, 1.1%, 1.2%, 1.3%, 1.4%, 1.5%, 1.6%, 1.7%, 1.8%, 1.9%, 2.0%, 2.1%, 2.2%, 2.3%, 2.4%, 2.5%, 2.6%, 2.7%, 2.8%, 2.9%, or 3.0%, by weight of a buffer, and all ranges and subranges therein. Sodium bicarbonate is the preferred buffering agent because of safety, cost, and acceptability in food applications.

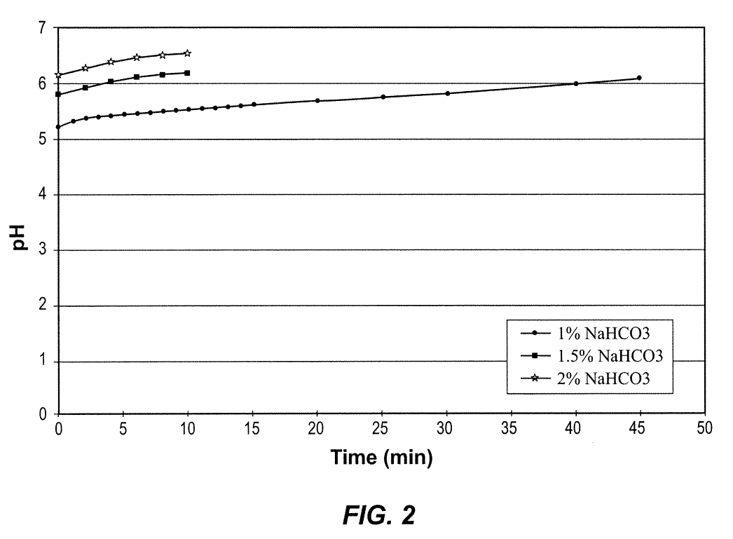

FIG. 2 contains three plots showing the effect of adding 1%, 1.5%, or 2%, by weight, sodium bicarbonate to a brine containing 20% sodium chloride and 1% lactic acid, by weight, over time. It was observed that the brine pH slowly increased over time and that the brine pH was acceptable for a continuous sausage extrusion run at all three levels of added buffer.

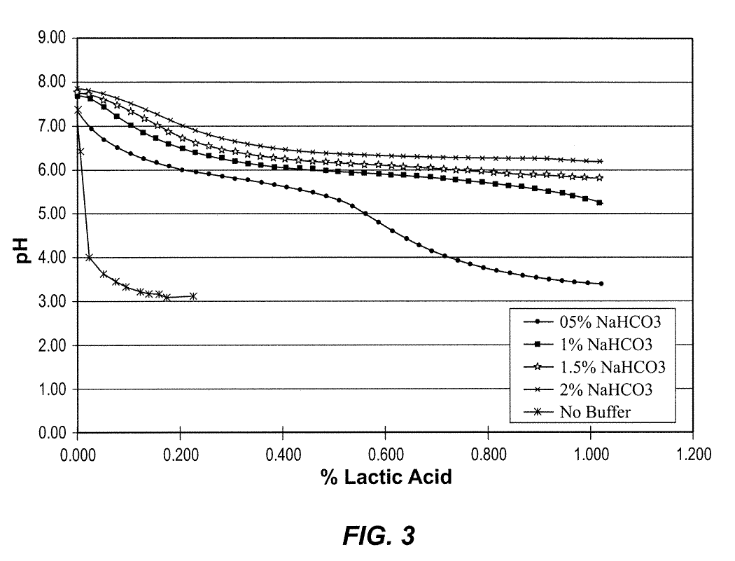

FIG. 3 contains plots of pH vs. lactic acid (%) for brines containing 20%, by weight, sodium chloride. Four brines containing 0.5%, 1%, 1.5%, and 2%, by weight, sodium bicarbonate were tested. In this test, lactic acid (85%, by weight) was added to each brine, dropwise, and the pH of the brine was measured. In the addition, 10 drops of the lactic acid (85%) is equivalent to 0.255 g lactic acid/100 ml brine; 20 drops is equivalent to 0.51 g/100 ml brine; 30 drops is equivalent to 0.77 g/100 ml brine; and 40 drops is equivalent to 1.02 g/100 ml.

The plots in FIG. 3 show a slow pH decrease for 1% through 2%, by weight, sodium bicarbonate. For 0.5%, by weight, sodium bicarbonate, the pH drops swiftly at about 0.5% titratable lactic acid. FIG. 3 also contains a comparative example for a 20% sodium chloride brine, by weight, lacking a buffer. The pH drops from 7.4 to 4 at less than 0.1 g/100 ml lactic acid. The brines containing 0.5% through 2% sodium bicarbonate permit an extended sausage production run, without a decrease in casing quality.

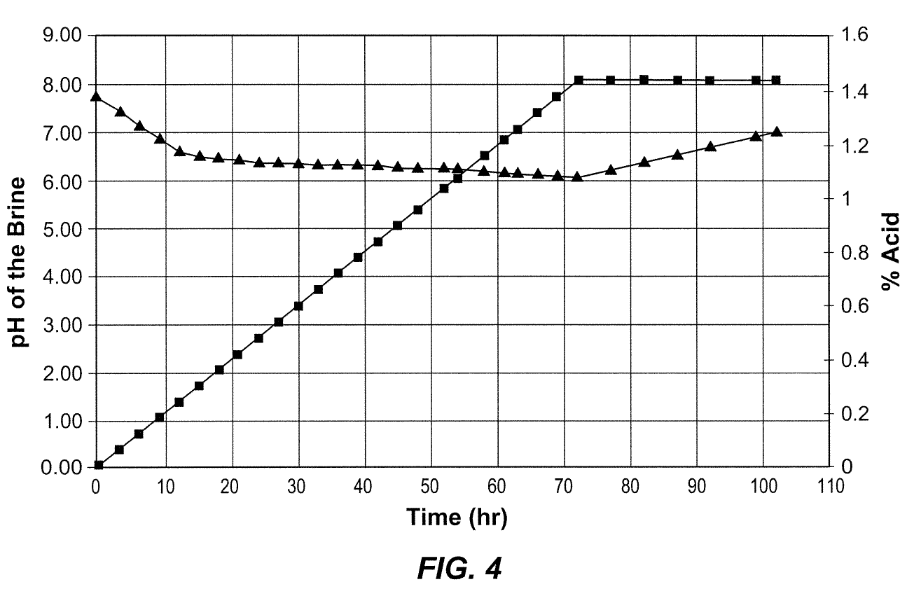

FIG. 4 contains plots showing the buffering effects of 1.5%, by weight, sodium carbonate buffer on a 20%, by weight, sodium chloride brine vs. time in a simulated sausage production run. In particular, an 800 ml sample of brine containing 20% sodium chloride and 1.5% sodium bicarbonate, by weight (total salinity 21.8%), was prepared. A mixture of 23.5 g lactic acid (85%) and 10 g acetic acid (2:1 lactic acid:acetic acid, by weight) was prepared (specific gravity 1.153 g/100 ml). The acid solution was added to the brine over time at the rate of 0.0012 g/min (of acid), and the pH and % lactic acid added was measured or calculated and plotted.

FIG. 4 shows that as lactic acid is added from 0 to 1.44%, by weight, over 72 minutes, the pH of the brine drops only from 7.70 to 6.08. After standing for an additional 30 minutes after the last lactic acid addition, the pH of the brine slowly rose from 6.08 to 7.02. The data shows that 1.5%, by weight, sodium bicarbonate maintains brine pH above 6 for 72 hours, which is a preferred pH for an extended sausage production run.

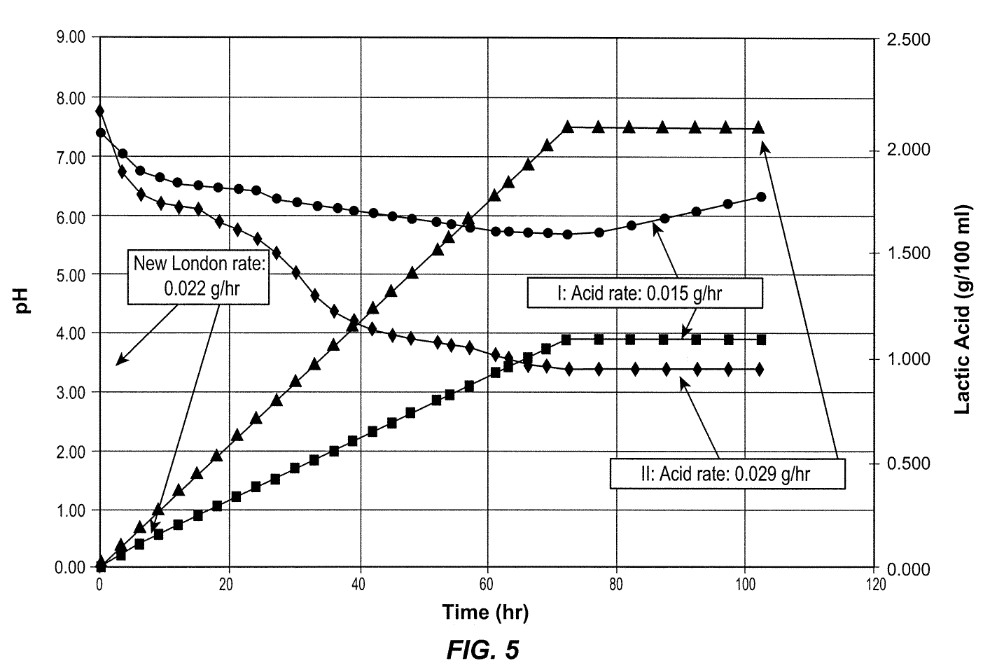

FIG. 5 contains plots showing the rate of acid introduction into the brine can effect brine pH and overwhelm the effects of a buffer. FIG. 5 shows the pH change difference in a 20% sodium chloride brine solution containing 1%, by weight, sodium bicarbonate buffer between an acid addition rate of 0.015 g lactic acid/hour and an addition of 0.029 g lactic acid/hour. At an acid addition rate of 0.015 g/hr., the amount of buffer (1%, by weight) was sufficient to maintain brine pH at about 6 or above for 100 hours, i.e., in the preferred pH range for an extended and continuous sausage run. At an acid addition rate of 0.029 g/hr, the 1% buffered system drops to a pH of below 6 after about 20 hours. After about 40 hours, casings prepared in a continuous extrusion process are adversely affected. At this increased rate of acid addition, the amount of buffer must be increased at the onset of the production run or add continuously during the run. Persons skilled in the art are readily able to calculate the amount of buffer that should be added prior to the production run or during the production run. If the buffering capacity of the brine is not maintained, the brine must be replaced and the productions run interrupted.

Buffering of a calcium salt brine for a collagen/alginate blend gel is important because the alginate is impacted greatly by chemistry changes, and particularly by pH changes. At a pH less than about 4, alginate rapidly loses its strong gel forming characteristics and thus should be avoided. After long operation times, the pH of calcium salt brine systems also drifts downward compromising the alginate chemistry and changing the gel characteristics of the collagen protein. Accordingly, a buffer, such as sodium carbonate, also is effective in increasing production run times for collagen/alginate systems that require a calcium brine.

The present invention therefore addresses the problem of increasing titratable brine acidity during extended extrusion runs in the manufacture of sausages. The present invention maintains brine pH near neutral and does not adversely affect the sausage or the casing. Sodium bicarbonate and other buffers reduce titratable acidity both by neutralizing the acid accumulating from the collagen gel dehydration process and by providing a necessary pH buffering effect to maintain the brine in a pH range of greater than about 3 to about 7.5. This pH range is typical in many food/meat systems and is known to have a minimal impact on a sausage flavor profile.

Sodium hydroxide, potassium hydroxide, and/or calcium hydroxide also can be added to a brine, but their function is solely to control pH only with no buffering effect. This is a disadvantage because pH control at near neutral pH conditions can be very difficult. Effective buffer levels are dependent on the acid content and type of the collagen gel used. It has been found for organic acid-based collagen gels that adding sodium bicarbonate and/or other buffering agents in an amount of about 0.5% to about 2.5%, by weight, to a saturated sodium chloride brine, and preferably about 1% to about 2%, results in sufficient pH control to allow at least 72 hours of continuous sausage manufacturing, and in some uses up to 144 hours.

Obviously, many modifications and variations of the invention as hereinbefore set forth can be made without department from the spirit and scope thereof, and therefore, only such limitations should be imposed as are indicated by the appended claims.

1. A method of preparing a casing for a foodstuff comprising:
(a) providing an extrudable foodstuff;
(b) providing a gel comprising an acid collagen;
(c) coextruding (a) and (b) to form a layer of the gel (b) on the foodstuff (a); then
(d) setting the extruded gel over the encased foodstuff by contacting the gel with a brine solution, said brine solution comprising about 0.1% to about 3%, by weight, of a buffer.

2. The method of claim 1 wherein the gel (b) further comprises a polysaccharide.

3. The gel of claim 2 wherein a weight ratio of collagen to polysaccharide is from 100:0 to about 30:70, on a dry weight basis.

4. The method of claim 2 wherein the polysaccharide comprises an alginate.

5. The method of claim 1 wherein the brine comprises up to a saturation amount of sodium chloride, a calcium brine, or a mixture thereof.

6. The method of claim 5 wherein the calcium brine comprises one or more of calcium chloride, calcium lactate, calcium citrate, and calcium nitrate.

7. The method of claim 1 wherein the buffer maintains a pH of the brine from above about 3 to about 8.5.

8. The method of claim 1 wherein the buffer maintains the pH of the brine from about 4 to about 7.5.

9. The method of claim 1 wherein the buffer maintains the pH of the brine from about 5 to about 7.

10. The method of claim 1 wherein the buffer maintains the titratable acidity of the brine from 0 to below about 0.2 mg/ml as lactic acid equivalent.

11. The method of claim 1 wherein the buffer maintains the titratable acidity of the brine from 0 to below about 0.15 mg/ml as lactic acid equivalent.

12. The method of claim 1 wherein the brine further comprises sodium hydroxide, potassium hydroxide, calcium hydroxide, or a mixture thereof.

13. The method of claim 1 wherein the buffer is selected from the group consisting of potassium tartrate, potassium phthalate, potassium phosphate, dipotassium phosphate, sodium phosphate, borate, potassium oxalate, glycine, citrate, glycylglycine, malate, formate, succinate, acetate, propionate, maleate, MES, bis-tris, ADA, carbonate, bicarbonate, ACES, PIPES, MOPSO, BIS-TRIS propane, BES, MOPS, HEPES, MOBS, DIPSO, TAPSO, pyrophosphate, HEPPSO, POPSO, tricine, trizma, EPPS, HEPPS, BICINE, HEPBS, TAPS, AMPD, TABS, AMPSO, taurine, and mixtures thereof.

14. The method of claim 1 wherein the buffer comprises sodium bicarbonate, dipotassium phosphate, or mixtures thereof.

15. The method of claim 1 wherein the brine comprises a saturation amount of sodium chloride and about 0.3% to about 2%, by weight, sodium bicarbonate.

16. The method of claim 1 wherein the coextrusion process is a continuous process.

17. The method of claim 16 wherein the continuous coextrusion process is run from 16 to 144 hours prior to regenerating the brine.

18. A method of preparing a food product by coextrusion, said food product comprising a filling material and a gel comprising an acid collagen and an optional polysaccharide, wherein the filling material and gel are coextruded to form a casing layer of the gel over the filling material, then contacting the casing layer with an aqueous salt solution further comprising about 0.2% to about 2.5%, by weight, of a buffer.

19. The method of claim 18 wherein the filling material comprises a meat product and the foodstuff is a sausage selected from the group consisting of a fresh sausage, a pork sausage, a turkey sausage, a vegetable sausage, and a breakfast sausage.

20. The method of claim 18 wherein the salt solution comprises a calcium chloride solution, a sodium chloride solution, a calcium lactate solution, or a mixture thereof.

21. The method of claim 20 wherein the buffer comprises sodium bicarbonate.

22. A method of manufacturing a shaped food product comprising:
(a) coextruding a meat or vegetable foodstuff and a gel comprising an acid collagen and an optional polysaccharide, wherein the meat or vegetable product is extruded as a cylindrical core encased by a layer of the gel, and
(b) contacting the food product of step (a) with an aqueous solution comprising a chloride salt and about 0.2% to about 2.5%, by weight, of a buffer.

23. The method of claim 22 wherein the meat or vegetable foodstuff is extruded through a center port and the gel is extruded through an annular port surrounding the center port.

24. The method of claim 23 wherein the chloride salt comprises sodium chloride, calcium chloride, or a mixture thereof.

25. The method of claim 23 wherein the aqueous solution further comprises a calcium salt of an organic acid.

26. The method of claim 25 wherein the calcium salt comprises calcium lactate.
